(19) United States
(12) Patent Application Publication
(10) Pub. No.: US 2016/0247376 A1
(43) Pub. Date: Aug. 25, 2016

(54) MONITORING DEVICE

(71) Applicant: Zhe Zhang, Foster City, CA (US)

(72) Inventor: Zhe Zhang, Foster City, CA (US)

(21) Appl. No.: 14/880,958

(22) Filed: Oct. 12, 2015

Related U.S. Application Data
(60) Provisional application No. 62/119,338, filed on Feb. 23, 2015.

(51) Int. Cl. G08B 21/02

(52) U.S. Cl. CPC G08B 21/02

(57) ABSTRACT

A method to manage a hazardous condition is described. The method may include receiving, from a set of sensor devices, a temperature attribute and a first motion attribute. The method may include monitoring a motion sensor for a second motion attribute. The method may also include determining an existence of a hazardous condition based on a combination of the temperature attribute and the first motion attribute, and after monitoring the motion sensor for the second motion attribute for a threshold amount of time without receiving the second motion. The method may include sending a message indicative of the hazardous condition to a client device.

### RELATED APPLICATION

This application claims priority to U.S. Provisional Patent Application No. 62/119,338, filed Feb. 23, 2015, which is herein incorporated by reference.

### FIELD

The embodiments discussed herein are related to a monitoring device.

### SUMMARY

According to an aspect of an embodiment, a method to manage a hazardous condition may include receiving, from a set of sensor devices, a temperature attribute and a first motion attribute. The method may include monitoring a motion sensor for a second motion attribute. The method may also include determining an existence of a hazardous condition based on a combination of the temperature attribute and the first motion attribute, and after monitoring the motion sensor for the second motion attribute for a threshold amount of time without receiving the second motion. The method may include sending a message indicative of the hazardous condition to a client device.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments may be implemented;

FIG. 2 illustrates an example flow diagram of a method to manage a hazardous condition that may be implemented in the operating environment of FIG. 1;

FIG. 3 illustrates another example flow diagram of a method to manage a hazardous condition;

FIG. 4 illustrates a further example flow diagram of a method to manage a hazardous condition; and

FIG. 5 illustrates a diagrammatic representation of a machine in an example form of a computing device within which a set of instructions, for causing the machine to perform any one or more of the methods discussed herein, may be executed.

### DESCRIPTION OF EMBODIMENTS

Most homes and many commercial buildings include cooking facilities. Unattended cooking appliances may be a major cause of fires and fire related injuries in buildings. Moreover, even before a fire, cooking appliances may be a source of other injuries, including burns on curious children, carbon monoxide poisoning, among others. Embodiments described herein are directed to reducing fires and fire related injuries that may occur in any cooking facility. In at least one embodiment, a monitoring device may include a set of sensors that may include one or more of: at least one carbon monoxide sensor, at least one temperature sensor, and at least one motion sensor. The monitoring device may be installed near a heat-generating appliance, such as a stove or an oven. The set of sensors of the monitoring device may sense the atmospheric conditions of the cooking facility to automatically notify a homeowner or building manager of potentially hazardous conditions. The monitoring device may monitor for any hazardous condition, such as a carbon monoxide buildup, unsupervised stove usage, and/or children who may be near hot elements. Should a hazardous condition exist, the device may send a message to the homeowner or building manager to notify them of the hazardous condition.

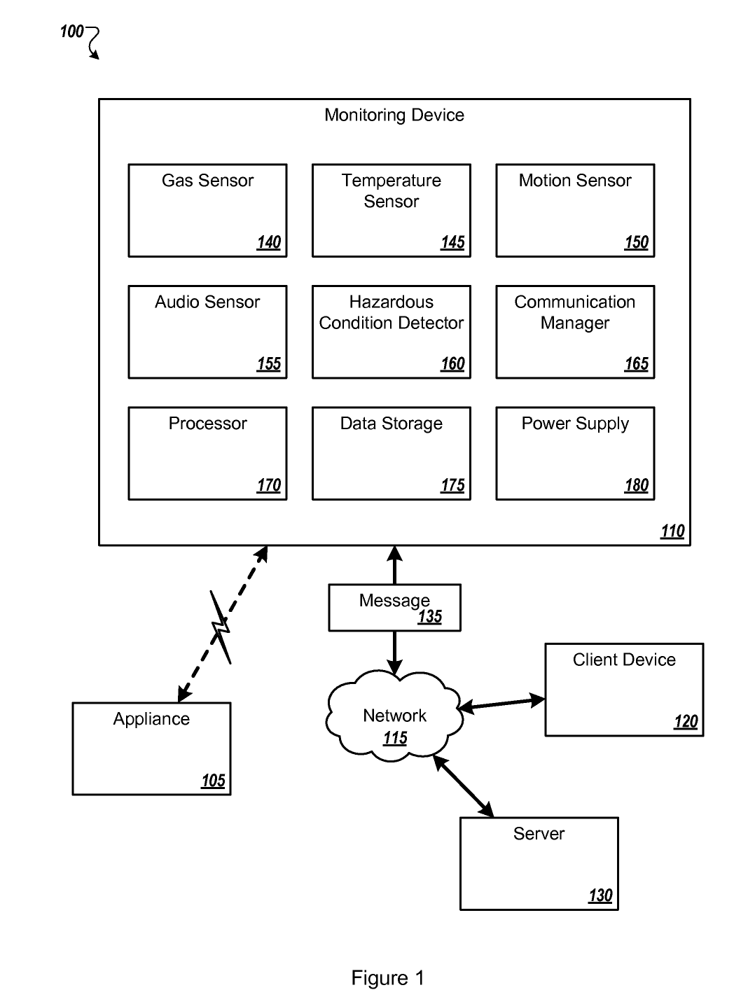

FIG. 1 illustrates a block diagram of an example operating environment 100 in which some embodiments may be implemented, arranged in accordance with at least one embodiment described herein. The operating environment 100 may include an appliance 105, a monitoring device 110, a network 115, a client device 120 and a server 130.

The appliance 105 may include any device that may potentially cause a hazardous condition. For example, the appliance 105 may include any kitchen appliance (e.g., stove, oven, refrigerator). In at least one embodiment, the appliance 105 includes an appliance that may cause a hazardous condition that relates to decreased air quality and an unsafe temperature.

The monitoring device 110 may detect one or more environmental attributes within the environment 100 and determine, based on the one or more environmental attributes, whether a hazardous condition exists. Typically, the hazardous condition may be related to the appliance 105. The monitoring device 110 may use one or more sensors to detect the environmental attributes. Example environmental attributes may include air composition, a presence of a gas, an amount of the gas, temperature, movement, sounds, and other environmental attributes within the environment 100. Based on an analysis of the environmental attributes, the monitoring device 110 may determine that a hazardous condition exists and the monitoring device 110 may send, via the network 115, a message 135 that indicates the hazardous condition. The message 135 may indicate any details that relate to the hazardous condition, such as an ambient temperature, a localized temperature (e.g., a temperature of a stove heating coil), an air quality metric, an air composition metric, a motion characteristic of an object in the environment 100 (e.g., movement of a person in the environment 100), a sound characteristic (e.g., a sound of a person, a typical sound of a hazardous condition), among others. The client device 120 may receive the message 135 that indicates the hazardous condition and may present at least some of the contents of the message 135 via a display. A user of the client device 120 may receive notification of the hazardous condition via the client device 120. The message 135 may be in any computer-readable format. In at least one embodiment, the message 135 is an audio and/or visual alert that is produced by the monitoring device. The audio and/or visual alert may indicate to people in the vicinity of the appliance 105 that a hazardous condition may exist. In at least one embodiment, the monitoring device 110 is part of or integrated into the appliance 105. n at least one embodiment, the monitoring device 110 is part of or integrated into a range hood.

In general, the network 115 may include one or more wide area networks (WANs) and/or local area networks (LANs) that enable the monitoring device 110, the client device 120 and/or the server 130 to communicate with each other. In some embodiments, the network 115 includes the Internet, including a global internetwork formed by logical and physical connections between multiple WANs and/or LANs. Alternately or additionally, the network 115 may include one or more cellular RF networks and/or one or more wired and/or wireless networks such as, but not limited to, 802.xx networks, Bluetooth access points, wireless access points, IP-based networks, or the like. The network 115 may also include servers that enable one type of network to interface with another type of network.

The client device 120 may include a computing device which may include, but is not limited to, a desktop computer, a laptop computer, a tablet computer, a mobile phone, a smartphone, a personal digital assistant (PDA), or other suitable computing device. A user may use the user device to view one or more messages 135 that relate a hazardous condition in environment 100. The client device 120 typically may communicate with the communication manager 165 and/or the server 130 over network 115. The client device 120 may include a display and a graphical user interface (GUI) by which messages may be presented to a user. In at least one embodiment, the client device 120 includes an application (“app”) that may be downloaded from an application store. The app may be configured to receive a message from the communication manager 165 and/or the server 130 and may present the message via the GUI.

The example operating environment 100 may include any number of servers 130 that each may host, store and/or messages 135 relating to a hazardous condition in the environment 100. The server 130 may include one or more computing devices, (such as a rackmount server, a router computer, a server computer, a personal computer, a mainframe computer, a laptop computer, a web server, a proxy server, a desktop computer, etc.), data stores (e.g., hard disks, memories, databases), networks, software components, and/or hardware components. The server may be a cloud-based server that hosts a monitoring platform. The server 130 may receive messages indicative of a hazardous condition, determine a course of action to attempt to remedy the hazardous condition, send a message to the client device 120, receive instructions related to the course of action from the client device 120, and send instructions to the monitoring device 110 and/or the appliance 105 on the course of action to potentially remedy the hazardous condition.

The monitoring device 110 may include a hardware device that includes a gas sensor 140, temperature sensor 145, motion sensor 150, audio sensor 155, hazardous condition detector 160, communication manager 165, processor 170, data storage 175, and a power supply 180. In the illustrated embodiment, the monitoring device 110 may be coupled to the network 115 to send and receive data to and from the client device 120 and/or the server 130 via the network 115. The monitoring device 110 may include a set of instructions executable by a processor to provide the functionality described herein. In some instances, the hazardous condition detector 160 and/or the communication manager 165 may be stored in or at least may be temporarily loaded into the data storage 175 and may be accessible and executable by the processor 170. Alternatively or additionally, one or more of the hazardous condition detector 160 and the communication manager 165 may be implemented in hardware.

The gas sensor 140 may detect a presence and/or an amount of gas within the environment 100. The gas sensor 140 may be configured to detect one or more gases. Example the gas sensors 140 may include a carbon monoxide detector, natural gas detector, among others. The gas sensor 140 may detect any type of gas, or combination of gases. Upon detecting a gas, the gas sensor 140 may produce a signal indicative of the detected gas and may send the signal to the hazardous condition detector 160.

The temperature sensor 145 may detect ambient temperature of the environment 100. Alternatively, the temperature sensor 145 may detect a local temperature of the appliance 105 or a specific component of the appliance. For example, the temperature sensor 145 may be configured to detect a temperature of a heating coil of a stove. The temperature sensor 145 may be any type of sensor used to detect temperature, such as a contact or noncontact temperature sensor. Contact sensors may include thermocouples and thermistors that touch the object they are to measure. Noncontact sensors may measure a thermal radiation from a heat source. Noncontact sensors may measure temperature from a distance and often are used in domestic applications to prevent hazardous environments. An example of a noncontact sensor may include an infrared temperature sensor. The temperature sensor 145 may produce a signal indicative of the detected temperature and may send the signal to the hazardous condition detector 160.

The motion sensor 150 may detect movement of an object. In at least one embodiment, the object may be a human. The motion sensor 150 may be an infrared sensor (e.g., a passive infrared detectors, pyro-electric infrared sensor) that may detect infrared wavelengths radiated from a human. In at least one embodiment, readings from the motion sensor 150 may be provided as signals to the hazardous condition detector 160 every 200-300 millisecond. The motion sensor 150 may produce a signal indicative of the detected motion and may send the signal to the hazardous condition detector 160.

The audio sensor 155 may detect sounds within the environment 100. The audio sensor 155 may detect any sound, such as a sound coming from the appliance 105, a human in the environment 100, a sound related to a hazardous condition, etc. The audio sensor 155 may produce a signal indicative of the detected audio and may send the signal to the hazardous condition detector 160.

The hazardous condition detector 160 may use data from the various sensors 140, 145, 150 and 155 to monitor activity of and around the appliance 105. The hazardous condition detector 160 may interpret one or more signals from at least one sensor to determine whether a hazardous condition exists in the environment 100. For example, when the gas sensor 140 is a carbon monoxide detector and the gas sensor 140 reads levels of carbon monoxide that are above a permissible carbon monoxide threshold, the hazardous condition detector 160 may determine a hazardous condition exists because the excessive carbon monoxide is in the environment 100. Similarly, when the temperature sensor 145 measures a temperature (e.g., ambient or local to the appliance 105) that exceeds a temperature threshold, the hazardous condition detector 160 may determine that the current temperature creates a hazardous condition. In a further embodiment, the hazardous condition detector 160 may match the signal received from the audio sensor 155 to a specific sound indicative of a hazardous condition (e.g., the sounds of a fire burning, a person in distress). When the signal received from the audio sensor 155 matches a specific sound indicative of a hazardous condition, the hazardous condition detector 160 may determine that a hazardous condition exists.

In at least one embodiment, the hazardous condition detector 160 may identify a combination of sensor readings and, based on that combination, determine that a hazardous condition exists in the environment 100. For example, when the hazardous condition detector 160 determines that the appliance 105 is on based on temperature sensor 145 data, and that nothing has tripped the motion sensor 150 after a threshold amount of time, the hazardous condition detector 160 may determine that the appliance 105 is powered on and left unattended, thereby creating a hazardous condition.

In at least one embodiment, the hazardous condition detector 160 may take action to attempt to remedy the hazardous condition. For example, the hazardous condition detector 160 may identify carbon monoxide in the environment 100 and may send an instruction to the appliance 105 to shut itself off. In at least one embodiment, the hazardous condition detector 160 may be coupled to an electrical and/or gas shutoff switch or valve and, upon an occurrence of a hazardous condition, the hazardous condition detector 160 may actuate the electrical and/or gas shutoff switch or valve to cut a power and/or gas supply to the appliance 105. The hazardous condition detector 160 may use data from the temperature sensor 145 to determine if the appliance 105 is in use.

When a hazardous condition exists in the environment 100, the hazardous condition detector 160 may create the message 135 that indicates that a hazardous condition exists in the environment 100. The message 135 may be a warning message that may be used to inform a user of the hazardous condition. The message 135 may report any action taken by hazardous condition detector 160 (e.g., shutoff power to the appliance 105). The message 135 may also include a request that the user takes action to remedy the hazardous condition.

The communication manager 165 may include a network interface configured to send the message 135 to the client device 120.

The processor 170 represents one or more general-purpose processors such as a microprocessor, central processing unit, or the like. More particularly, the processor 170 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 170 may also include one or more special-purpose processing devices such as an application specific integrated circuit (ASIC), a field programmable gate array (FPGA), a digital signal processor (DSP), network processor, or the like. The processor 170 is configured to execute instructions for performing the operations and steps discussed herein.

In at least one implementation, the data storage 175 may include a memory (e.g., random access memory), a cache, a drive (e.g., a hard drive), a flash drive, a database system, or another type of component or device capable of storing data. The data storage 175 may also include multiple storage components (e.g., multiple drives or multiple databases) that may span multiple computing devices (e.g., multiple server computers).

The power supply 180 may provide electric energy to the monitoring device 110. The power supply 180 may to convert one form of electrical energy (e.g., alternating current) to another (e.g., direct current).

In at least one embodiment, the monitoring device 110 includes at least two motion sensors 150. A first motion sensor device may be positioned to detect an adult presence in the environment 100. The first motion sensor device may scan movement around the top of the appliance 105 from the average chest height of a person and above. The first motion sensor device may detect people of an adult height and allow the monitoring device 110 to determine if a person is supervising the appliance 105. When first motion sensor device is tripped, it may send a signal to the hazardous condition detector 160. The hazardous condition detector 160 may reset an internal clock that counts down how long the appliance 105 has been left unattended. When the clock reaches a threshold duration of time during which the first motion sensor does not detect motion, the hazardous condition detector 160 may detect that a hazardous condition exists.

A second motion sensor device may be positioned to detect motion around the appliance 105. The second motion sensor device may be aimed toward a bottom portion of the appliance 105. The second motion sensor device may be triggered by any object that moves near the appliance 105 no matter the height of the object. A scanning zone of the second motion sensor device may be below the waistline of an average adult. If the second motion sensor device is tripped, the second motion sensor device may send a signal to the hazardous condition detector 160 that indicates the second motion sensor device has been tripped. The hazardous condition detector 160 may check to see whether the first motion sensor device has been tripped. When the first motion sensor device does not detect an object and the second motion sensor device does detect an object around the appliance 105, the hazardous condition detector 160 may determine that a child is near the appliance 105. Using temperature data from the temperature sensor 145, the existence of data from the second motion sensor and the lack of data from the first motion sensor, the hazardous condition detector 160 may determine that this combination of sensor data corresponds to the hazardous condition of a child being near a powered-on appliance 105. The communication manager 165 may send a message 135 to the client device 120 to inform a parent of this potential hazardous condition that their child may be playing near the appliance 105.

In another example, the hazardous condition detector 160 may use data from the temperature sensor that the appliance 105 is on, and use data from the motion sensor 150 to determine a potential hazardous condition that the appliance 105 has been left on, and has been unattended, for an extended period of time. The communication manager 165 may send a message indicating this potential hazardous condition to the client device 120.

Other types of sensors may be used. For example, a smoke detector may be used to detect a possible fire hazard within the environment 100. The smoke detector may be configured to detect a potentially hazardous condition that includes excessive smoke in the environment 100.

In another example, a flowmeter may be used to measure the flow of a gas/liquid that is being used to fuel the appliance 105. For example, the flowmeter may be used with gas stoves to monitor the flow of gas to the stove. The flowmeter may be used to determine if the stove is in use when gas is flowing through to the stove. In a further example, an ammeter may be used to measure a current draw by the appliance 105. An increase in current would indicate the stove is being used and the current reading would give the device an instant indication of the stove's stove.

In another example, a humidity detector may be used to detect an increase in humidity, which may indicate that something is cooking and the appliance 105 is powered on.

Modifications, additions, or omissions may be made to the example operating environment 100 without departing from the scope of the present disclosure. Specifically, embodiments of the environment 100 are depicted in FIG. 1 as including one or more appliances 105, one or more monitoring devices 110, one or more networks 115, one or more client devices 120, one or more servers 130, one or more gas sensors 140, one or more temperature sensors 145, one or more motion sensors 150, one or more audio sensors 155, one or more hazardous condition detectors 160, one or more communication managers 165, one or more processors 170, one or more data storages 175, and one or more power supplies 180. However, the present disclosure applies to an environment 100 including one or more networks 102, one or more document servers 104, one or more user devices 108, one or more topic label generation systems 105, one or more topic label refinement systems 106, one or more data storages 175, or any combination thereof.

Moreover, the separation of various components in the embodiments described herein is not meant to indicate that the separation occurs in all embodiments. Additionally, it may be understood with the benefit of this disclosure that the described components may be integrated together in a single component or separated into multiple components.

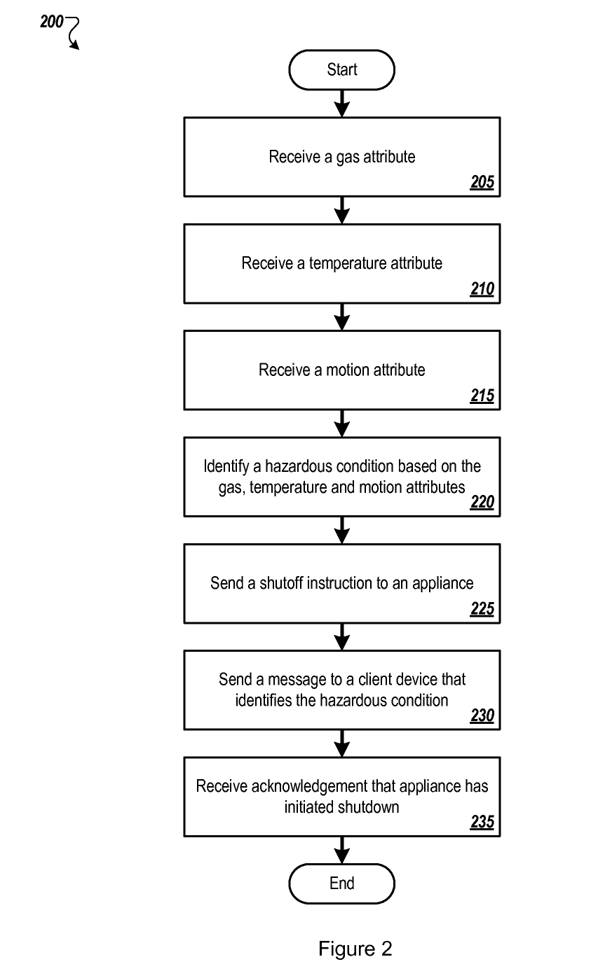

FIGS. 2-4 are flow diagrams of various methods related to identifying a hazardous condition in an environment. The methods may be performed by processing logic that may include hardware (circuitry, dedicated logic, etc.), software (such as is run on a general purpose computer system or a dedicated machine), or a combination of both, which processing logic may be included in the hazardous condition detector 160 or another computer system or device. For simplicity of explanation, methods described herein are depicted and described as a series of acts. However, acts in accordance with this disclosure may occur in various orders and/or concurrently, and with other acts not presented and described herein. Further, not all illustrated acts may be required to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. The methods illustrated and described in conjunction with FIGS. 2-4 may be performed, for example, by a system such as the hazardous condition detector 160 of FIG. 1. However, another system, or combination of systems, may be used to perform the methods. Although illustrated as discrete blocks, various blocks may be divided into additional blocks, combined into fewer blocks, or eliminated, depending on the desired implementation.

FIG. 2 illustrates an example flow diagram of a method 200 to manage a hazardous condition in an environment that may be implemented in the operating environment of FIG. 1, arranged in accordance with at least one embodiment described in the present disclosure.

The method 200 may begin at block 205, where processing logic may receive a gas attribute from a first sensor device. The first sensor device may be the gas sensor 140 of FIG. 1. The gas attribute may be a measurement of an amount of gas in an environment. The gas attribute may include an amount of a particular type of gas present in the ambient air. For example, the gas attribute may indicate the presence of a gas in terms of parts per million.

At block 210, the processing logic may receive a temperature attribute of an appliance from a second sensor device. The second sensor device may be the temperature sensor 145 of FIG. 1. The temperature attribute may be a measurement of a temperature of an appliance or of a component of the appliance.

At block 215, the processing logic may receive a motion attribute from a third sensor device. The third sensor device may be the motion sensor 150 of FIG. 1. The motion attribute may be a measurement of a motion of an object (e.g., a human) in the environment. The motion attribute may include motion information of an object near the appliance.

At block 220, the processing logic may identify a hazardous condition based on the gas attribute, the temperature attribute, and the motion attribute. For example, when the gas attribute detects a level of gas (e.g., carbon monoxide) above a gas threshold, a temperature above a temperature threshold (which may indicate that the appliance is hot) and a particular motion attribute (e.g., the motion attribute is indicative of a child who is near the hot appliance), the processing device may determine that a combination of the gas attribute, the temperature attribute, and the motion attribute corresponds to a hazardous condition. The processing logic may identify an appliance related to the hazardous condition. For example, when the temperature sensor is associated with a stove, and the temperature sensor reads temperature levels above a temperature threshold, the processing logic may determine that the stove is associated with the hazardous condition.

At block 225, the processing logic may send a shutoff instruction to the appliance. The shutoff instruction may include an instruction to completely power off the appliance. In at least one embodiment, the shutoff instruction includes an instruction to shut off a component of the appliance. For example, the shutoff instruction may include an instruction to shutoff one or more burner of a stove. The stove may shutoff the one or more burners while the appliance generally remains powered on. In this state, the stove may receive further instructions to power on the one or more burners.

At block 230, the processing logic may send a message indicative of the hazardous condition to a client device. The message may include any of the attributes received at blocks 205, 210 and/or 215. The message may include a warning message to notify a user of the client device of the hazardous condition. The message may include an invitation to power off the appliance, or to power off a component of the appliance. For example, in response to receiving the message, the client device may display at least a portion of the message in a graphical format. The graphical format of the message may include a prompt that asks a user if they desire to power off the appliance. The client device may receive an input from the user via to power off the appliance. The client device may send the input received from the user to the processing logic. In this example, the processing logic may execute block 230 before block 225 and may execute block 225 in response to receive the input from the client device.

At block 235, the processing logic may receive an acknowledgement from the appliance that the appliance has initiated a shutdown of the appliance or of the component of the appliance.

For this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

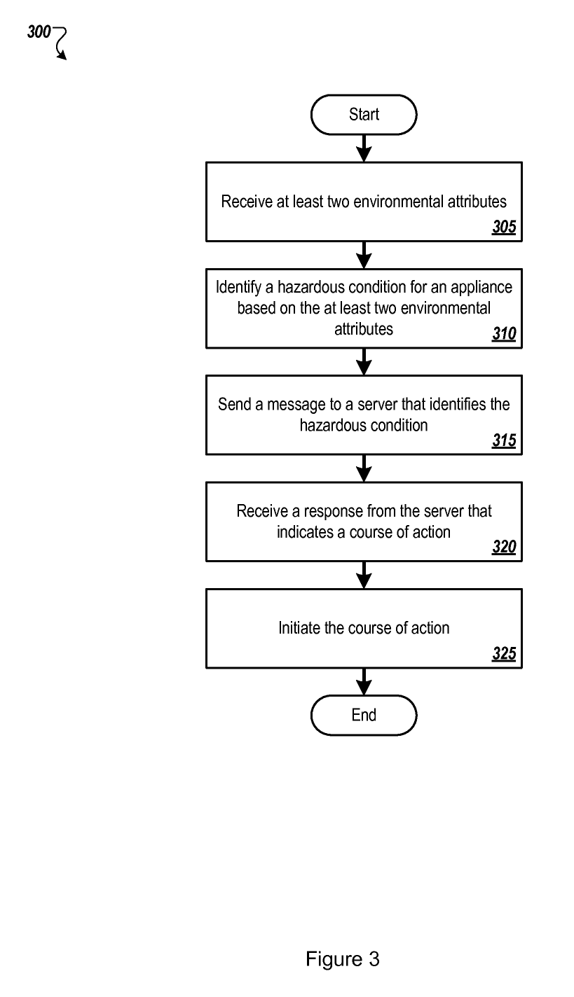

FIG. 3 illustrates another example flow diagram of a method 300 to manage a hazardous condition in an environment. At block 305, the processing logic may receive at least two environmental attributes from a set of sensor devices. In at least one embodiment, the processing logic may receive a temperature attribute and a first motion attribute.

At block 310, the processing logic may identify a hazardous condition for an appliance based on the at least two environmental attributes. For example, the temperature attribute may be a temperature that exceeds a temperature threshold and the first motion attribute may be indicative of a child in the environment. The processing logic may determine that this combination of environmental attributes relates to a hazardous condition or to a potential hazardous condition.

At block 315, the processing logic may send a message to a server that identifies the hazardous condition. The server may be a cloud-based server that hosts a monitoring platform. In at least one embodiment, the monitoring platform automatically send instructions to remedy the hazardous condition to the processing logic or to an appliance associated with the hazardous condition.

The monitoring platform may be accessible by a user from any location and using any type of device. The monitoring platform may be configurable to communicate with any client device, such as via an application or a web browser. The user may configure the monitoring platform to send messages to their personal cell phone. In response to receiving the message that identifies the hazardous condition, the server may send the message to the personal cell phone. The message may notify the user of the hazardous condition and any remedial action that may have been performed. Alternatively, the monitoring platform may notify the user (e.g., via the personal cell phone) of the hazardous condition and request that the user indicate a remedial action to perform to remedy the hazardous condition. The monitoring platform may determine a remedial course of action (on its own or based on input from the user) and may send the course of action to the processing logic.

At block 320, the processing logic may receive a response from the server that indicates the course of action. As discussed herein, the course of action may include shutting down the appliance or a component of the appliance. At block 335, the processing logic may initiate the course of action.

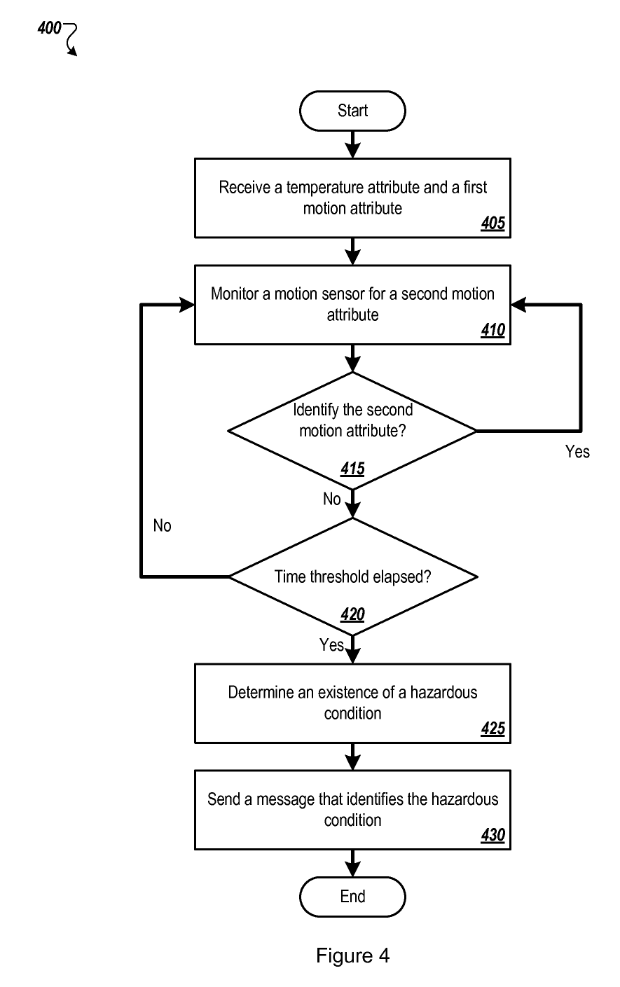

FIG. 4 illustrates a further example flow diagram of a method 400 to manage a hazardous condition in an environment. At block 405, processing logic may receive a temperature attribute and a first motion attribute. The temperature attribute may include a temperature associated with an appliance. The first motion attribute may include motion information of an object near the appliance. The first motion attribute may be received via a first motion sensor that may be positioned to identify motion between a floor and a distance from the floor that is less than an average height of a human adult. For example, the first motion sensor may be configured to detect an adult and a child.

At block 410, the processing logic may monitor a motion sensor (e.g., a second motion sensor) for a second motion attribute. The second motion sensor may be positioned to identify motion between a midsection of an average height of a human adult and an upper height threshold. For example, the second motion sensor may be configured to detect an adult and not a child.

At block 415, the processing logic may determine whether the motion sensor (e.g., the second motion sensor) has detected the second motion attribute. For example, the processing logic may determine whether a person of an average adult size has moved within the environment.

In response to detecting the second motion attribute (“YES” at block 415), the processing logic may loop to block 410 to monitor the motion sensor for the second motion attribute. In at least one embodiment, the processing logic may reset a timer after detecting the second motion attribute.

In response to not detecting the second motion attribute (“NO” at block 415), at block 420, the processing logic may determine whether a time threshold has elapsed. In response to determining that the time threshold has elapsed (“YES” at block 420), at block 425, the processing logic may determine an existence of a hazardous condition. For example, the hazardous condition may be determined based on blocks 405, 415 and 420. For example, the temperature attribute received at block 405 may indicate that attribute indicates that the appliance is hot. The first motion attribute of the object may indicate that a human is near the hot appliance. The absence of the second motion attribute within the time threshold may indicate that the human is a child. In at least one embodiment, the processing logic may receive a signal from the first motion sensor, which may indicate that a child remains in the environment. In response to determining that the time threshold has not elapsed (“NO” at block 420), at block 425, the processing logic may loop to block 410 or block 415.

At block 430, the processing logic may send a message (e.g., informational, call to action) that identifies the hazardous condition to a client device and/or to a server, as described herein.

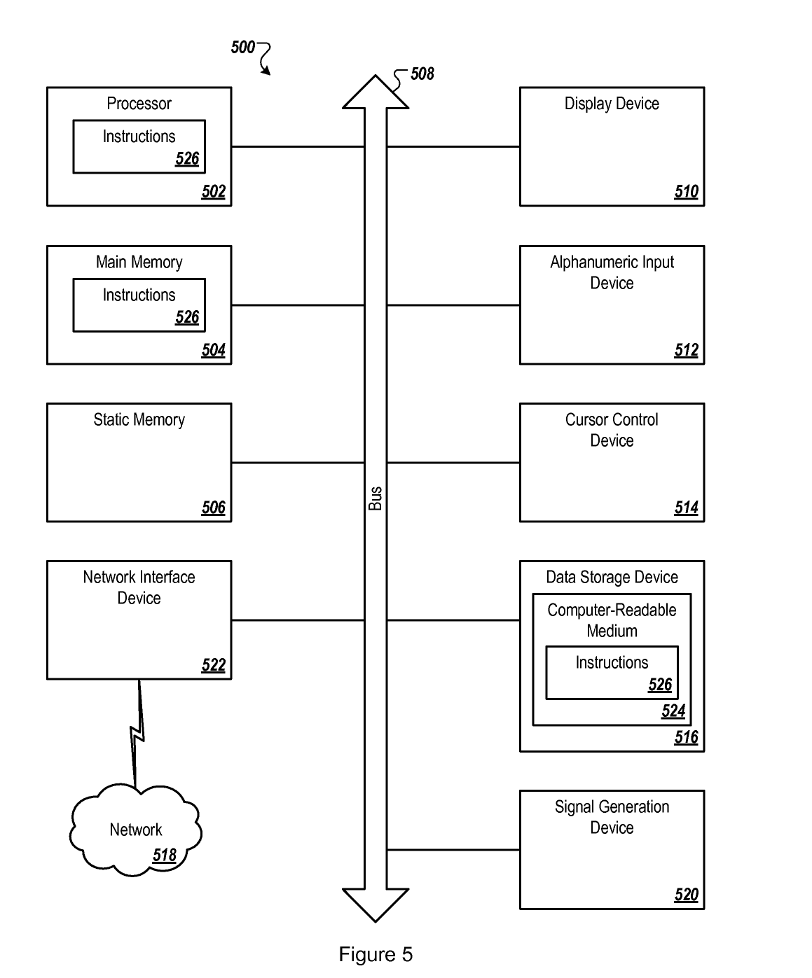

FIG. 5 illustrates a diagrammatic representation of a machine in the example form of a computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 500 includes a processing device (e.g., a processor) 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 515, which communicate with each other via a bus 508.

Processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 (e.g., system 105) embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 526 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used herein and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it may be understood that the various changes, substitutions, and alterations may be made hereto without departing from the spirit and scope of the present disclosure.

What is claimed is:

1. A method comprising:
receiving a gas attribute from a first sensor device;
receiving a temperature attribute of an appliance from a second sensor device;
receiving a motion attribute from a third sensor device;
determining that a combination of the gas attribute, the temperature attribute, and the motion attribute corresponds to a hazardous condition; and
sending a message indicative of the hazardous condition to a client device.

2. The method of claim 1, wherein the gas attribute includes an amount of a particular type of gas present in ambient air, wherein the temperature attribute includes a temperature associated with an appliance, and wherein the motion attribute includes motion information of an object near the appliance.

3. The method of claim 2, wherein the motion attribute is received via a motion sensor that is positioned to identify motion between a floor and a distance from the floor that is less than an average height of a human adult.

4. The method of claim 3, wherein the temperature attribute indicates that the appliance is hot, and wherein the motion attribute of the object is indicative of a child who is near the hot appliance.

5. The method of claim 3 further comprising:
receiving a second motion attribute from a fourth sensor device; and
receiving a third motion attribute from the third sensor device after a threshold amount of time since receiving the second motion attribute from the fourth sensor device; and
determining that the hazardous condition exists in view of receiving the third motion attribute after the threshold amount of time since receiving the second motion attribute from the fourth sensor device.

6. The method of claim 1 further comprising identifying an appliance related to the hazardous condition, wherein the message includes an invitation to power off the appliance.

7. The method of claim 6 further comprising receiving an instruction from the client device to turn off the appliance in view of the hazardous condition.

8. The method of claim 1, wherein sending the message indicative of the hazardous condition to the client device comprises sending the message to a cloud-based server, wherein the cloud-based server is to send the message to the client device.

9. The method of claim 1, wherein the message includes the gas attribute, the temperature attribute, and the motion attribute.

10. A non-transitory computer-readable medium having encoded therein programming code executable by a processor to perform or control performance of operations comprising:
receiving, from a set of sensor devices, a temperature attribute and a first motion attribute;
monitoring a motion sensor for a second motion attribute;
determining an existence of a hazardous condition based on a combination of the temperature attribute and the first motion attribute, and after monitoring the motion sensor for the second motion attribute for a threshold amount of time without receiving the second motion attribute; and
sending a message indicative of the hazardous condition to a client device.

11. The non-transitory computer-readable medium of claim 10, wherein the temperature attribute includes a temperature associated with an appliance, and wherein the first motion attribute includes motion information of an object near the appliance.

12. The non-transitory computer-readable medium of claim 11, wherein the first motion attribute is received via a first motion sensor that is positioned to identify motion between a floor and a distance from the floor that is less than an average height of a human adult.

13. The non-transitory computer-readable medium of claim 12, wherein the second motion attribute is received via a second motion sensor that is positioned to identify motion between a midsection of an average height of a human adult and an upper height threshold.

14. The non-transitory computer-readable medium of claim 12, wherein the temperature attribute indicates that the appliance is hot, and wherein the first motion attribute of the object is indicative of a human who is near the hot appliance, and wherein an absence of the second motion attribute is indicative that the human is a child.

15. The non-transitory computer-readable medium of claim 10, the operations further comprising identifying an appliance related to the hazardous condition, wherein the message includes an invitation to power off the appliance.

16. A system comprising:
a memory; and
a processing device operatively coupled to the memory, the processing device being configured to execute operations comprising:
receive, from a set of sensor devices, a temperature attribute and a first motion attribute;
monitor a motion sensor for a second motion attribute;
determine an existence of a hazardous condition based on a combination of the temperature attribute and the first motion attribute, and after monitoring the motion sensor for the second motion attribute for a threshold amount of time without receiving the second motion attribute; and
send a message indicative of the hazardous condition to a client device.

17. The system of claim 16, wherein the temperature attribute includes a temperature associated with an appliance, and wherein the first motion attribute includes motion information of an object near the appliance.

18. The system of claim 17, wherein the processing device is configured to receive the first motion attribute via a first motion sensor that is positioned to identify motion between a floor and a distance from the floor that is less than an average height of a human adult.

19. The system of claim 18 further comprising the second motion sensor, wherein the second motion sensor is positioned to identify motion between a midsection of an average height of a human adult and an upper height threshold.

20. The system of claim 18, wherein the temperature attribute indicates that the appliance is hot, and wherein the first motion attribute of the object is indicative of a human who is near the hot appliance, and wherein an absence of the second motion attribute is indicative that the human is a child.
